(19) United States
(12) Patent Application Publication
(10) Pub. No.: US 2018/0277272 A1
(43) Pub. Date: Sep. 27, 2018

(54) RADIATION SHIELDING TUBE, AND SHIELDING DEVICE AND METHOD

(71) Applicant: DAEWOO SHIPBUILDING & MARINE ENGINEERING CO., LTD., Seoul (KR)

(72) Inventors: Jin Kyu PARK, Geoje-si (KR); Dong Yeol KIM, Geoje-si (KR); Eul Seok Moon, Geoje-si (KR); Seaung Chae JU, Geoje-si (KR); Ha Taek JUNG, Geoje-si (KR); Man Joo HUH, Geoje-si (KR)

(21) Appl. No.: 15/765,459

(22) PCT Filed: May 12, 2016
(86) PCT No.: PCT/KR2016/004968

§ 371 Date: Apr. 2, 2018

(30) Foreign Application Priority Data
Oct. 1, 2015 (KR) 10-2015-0138462
Nov. 18, 2015 (KR) 10-2015-0161480

(51) Int. Cl. G21F 3/04; G21F 1/08

(52) U.S. Cl. CPC G21F 3/04; G21F 1/085

(57) ABSTRACT

Disclosed is a radiation shielding tube, wherein a guide tube is made of tungsten or the like, which is excellent in shielding performance, and is configured to be movable depending on various positions where a collimator is installed, so that the guide tube can effectively shield a radiation exposed during movement of a radiation source or RT work in the tube. The radiation shielding tube has a guide tube which is disposed between a radiation source container and a collimator and connects them to each other, and the guide tube is formed in an articular form to be bendable.

### TECHNICAL FIELD

The present invention relates to a radiation shielding tube, and shielding device and method, and more particularly, to a radiation shielding tube, which connects a radiation container and a collimator with each other to shield radiation leaking during movement of a radiation source or an RT test of a small-diameter pipe, and shielding device and method of the pipe for easily securing a source-to-film distance (SFD) during RT work of a relatively small-diameter pipe, which is less than 2 inches.

### BACKGROUND ART

In general, in connection with the RT work of the Nuclear Safeguards Act, radiation limitation regulations are strengthened, and technology for shielding radiation leaking during RT work due to a production delay caused by delay in RT work of pipes is being demanded. As an example, radiation allowance is less than 10 μSv/hr in case of RT workers and 1 μSv/hr in case of average workers, and a restricted area of the average workers is changing from within a 30m radius to within a 100m radius.

For your reference, RT work is a method for two-dimensionally recording a concentration difference on a film by a change in radiation intensity during irradiation of a specimen, namely, a transmission difference of a sound area and a defective area, and detecting defects, and is a method for detecting defects of a welded part of a pipe or castings.

As such a technology for shielding radiation, Korean Patent No. 10-1242731 published on Mar. 6, 2013 discloses a radiation source transfer pipe having a radiation shield, which minimizes an amount of radiation from a radiation source stop area to a worker, who is located at the rear, during a nondestructive inspection of a pipe that must keep an incidence angle of the radiation source at 360 degrees in order to remarkably reduce a radiation dose due to repeated nondestructive inspections inside the pipe.

That is, in order to improve productivity, shielding technology for progressing a simultaneous inspection in a small radius and reduce the restricted area of the average workers is required, and technology for connecting a tube between a radiation container and a collimator is applied.

FIG. 1 is a view showing a conventional guide tube.

Referring to FIG. 1, the conventional guide tube 4 connects a radiation source container 1 and a collimator 2 with each other so as to serve as a passage in which a radiation source moves, and is made of silicon or rubber. However, as shown in the drawing, while the radiation source 5 moves from the radiation source container 1 to the collimator 2 or during RT work, radiation is hardly shielded but is exposed to the air, so workers are exposed to radiation. Therefore, a device for shielding radiation more effectively is needed.

In the meantime, conventionally, a restricted area of average workers is set based on a radiation exposure allowance without shielding an inspection area during RT work of a field pipe, and the restricted area is indicated to restrict average workers' entrance. Moreover, even RT workers keep a safety distance away to progress work. Alternatively, the RT workers progress work in an RT room made of concrete or progress work after making and installing a thick shielding device made of lead.

In case of relative small-diameter pipes of less than 2 inches (1.5″, 1.0″, 0.5″, and so on), in order to clearly represent an image of a welded part on a film, a source-to-film distance (SFD) must be secured.

In case of RT work of small-diameter pipes of less than 2 inches, because photographing must be made while a fixed distance between the collimator and the pipe is kept, an amount of radiation exposed to the air is increased. Furthermore, it is urgent to develop a shielding device for RT work of small-diameter pipes of less than 2 inches because there are no shielding structure and method which can shield a certain distance away.

### DISCLOSURE

### Technical Problem

Accordingly, the present invention has been made in an effort to solve the above-mentioned problems occurring in the prior arts, and it is an object of the present invention to provide a radiation shielding tube, wherein a guide tube is made of tungsten or the like, which is excellent in shielding performance, and is configured to be movable depending on various positions where a collimator is installed, so that the guide tube can effectively shield radiation exposed during movement of a radiation source or RT work in the tube.

It is another object of the present invention to provide a shielding device and a shielding method of a pipe, which can easily shield by properly changing a position depending on a source-to-film distance (SFD) requiring a relatively small-diameter pipe of less than 2 inches, and effectively shield according to various field conditions while rotating at various angles.

### Technical Solution

To achieve the above objects, the present invention provides a radiation shielding tube including a guide tube connecting a radiation source container and a collimator with each other, wherein the guide tube is formed in an articular form to be bendable.

In another aspect of the present invention, the present invention provides a shielding device of a pipe including: a radiation shield configured to surround at least a part of the collimator or at least a part of the space between the collimator and the pipe to shield radiation investigated from the collimator; and a jig part which fixes the collimator and supports the radiation shield, wherein the jig part controls a distance between the collimator and the pipe.

In a further aspect of the present invention, the present invention provides a shielding method of a pipe including the steps of: mounting the shielding block and the film on the welding part of the pipe to be inspected; mounting the auxiliary shield supporter on the shielding block after adjusting the SFD according to the size of the pipe; mounting the central shield supporter and the collimator; mounting the articulated arms between the pipe and the central shield supporter; mounting the guide tube on the collimator; hanging the central shield on the central shield supporter; mounting side shields to surround the auxiliary shield supporter; and connecting the radiation source to the guide tube.

### Advantageous Effects

The radiation shielding tube according to an embodiment of the present invention can secure workers' safety by shielding radiation leaking toward the guide tube during movement of a radiation source or RT work in the tube.

The shielding device and method of a pipe according to the present invention can easily shield by properly changing a position depending on a source-to-film distance (SFD) requiring a relatively small-diameter pipe of less than 2 inches, and effectively shield according to various field conditions while rotating at various angles.

### DESCRIPTION OF DRAWINGS

FIG. 1 is a view of a conventional guide tube.

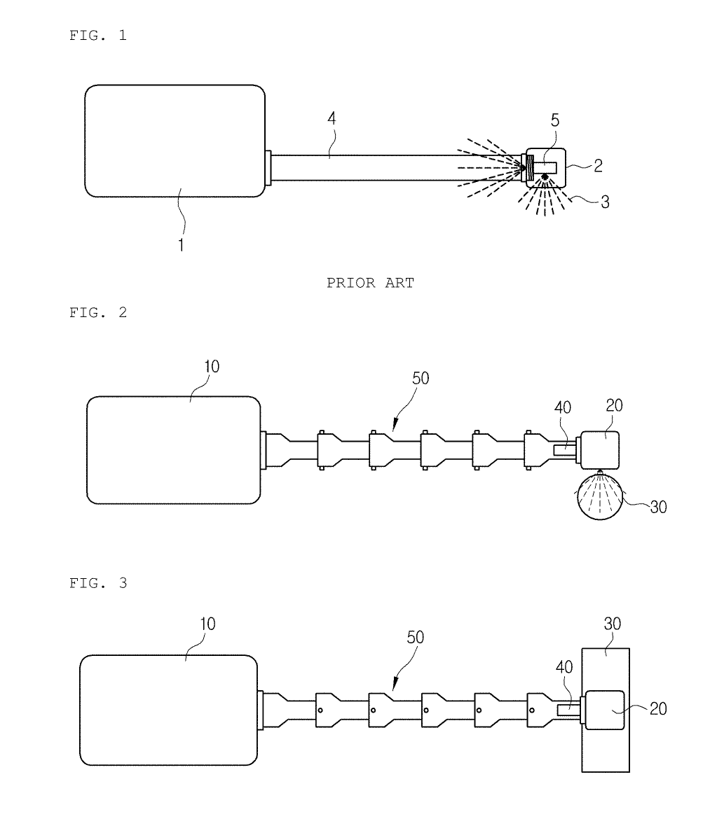

FIG. 2 is a front view of a radiation shielding tube according to a first preferred embodiment of the present invention.

FIGS. 3 and 4 are plan views of the radiation shielding tube according to the preferred embodiment of the present invention.

FIG. 5 is a sectional view of the radiation shielding tube according to the preferred embodiment of the present invention.

FIG. 6 is a sectional view showing a second shielding joint of the radiation shielding tube according to the preferred embodiment of the present invention.

FIG. 7 is a sectional view showing a third shielding joint of the radiation shielding tube according to the preferred embodiment of the present invention.

FIG. 8 is a sectional view showing a first shielding joint of the radiation shielding tube according to the preferred embodiment of the present invention.

FIG. 9 is a front view of a shielding device of a pipe according to a second preferred embodiment of the present invention.

FIG. 10 is a front view showing a jig part of the shielding device of the pipe according to the second preferred embodiment of the present invention.

FIG. 11 is a side view showing the jig part of the shielding device of the pipe according to the second preferred embodiment of the present invention.

FIG. 12 is a side view showing an auxiliary shield supporter of the shielding device of the pipe according to the second preferred embodiment of the present invention.

FIG. 13 is a side view showing a collimator holder of the shielding device of the pipe according to the second preferred embodiment of the present invention.

FIG. 14 is a side view showing a shielding block of the shielding device of the pipe according to the second preferred embodiment of the present invention.

FIG. 15 is a front view showing articulated arms of the shielding device of the pipe according to the second preferred embodiment of the present invention.

FIG. 16 is a view showing a radiation shield of the shielding device of the pipe according to the second preferred embodiment of the present invention.

FIG. 17 is a sectional view showing a guide tube of the shielding device of the pipe according to the second preferred embodiment of the present invention.

FIGS. 18 to 25 are views showing a shielding method of a pipe in order according to a third preferred embodiment of the present invention.

FIG. 26 is a flow chart showing the shielding method of the pipe according to the third preferred embodiment of the present invention.

### MODE FOR INVENTION

Hereinafter, reference will be now made in detail to a radiation shielding tube, a shielding device and a shielding method according to preferred embodiments of the present invention with reference to the attached drawings.

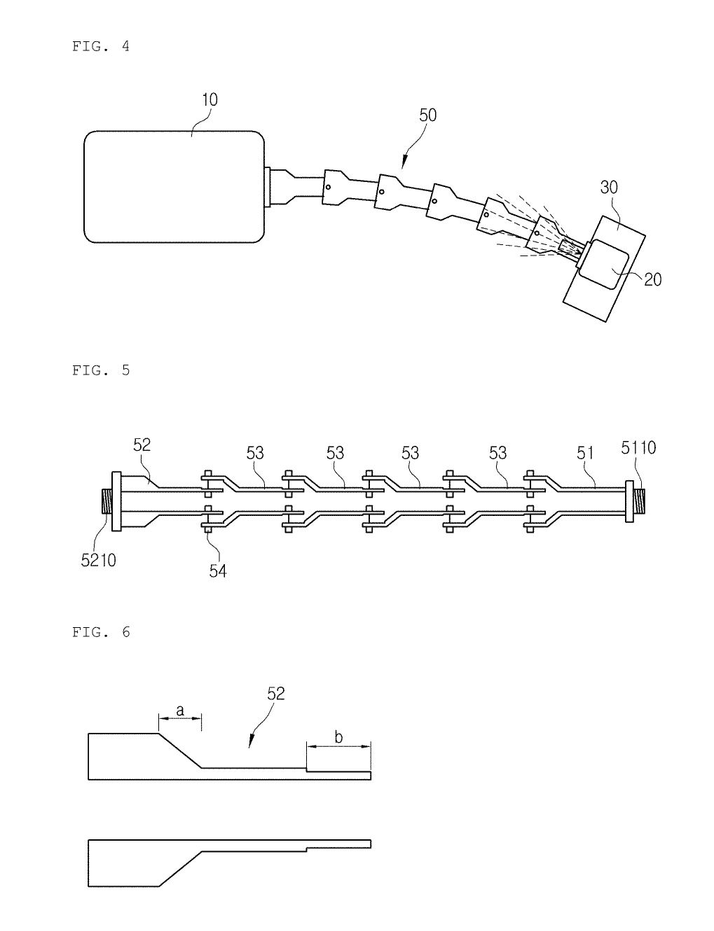

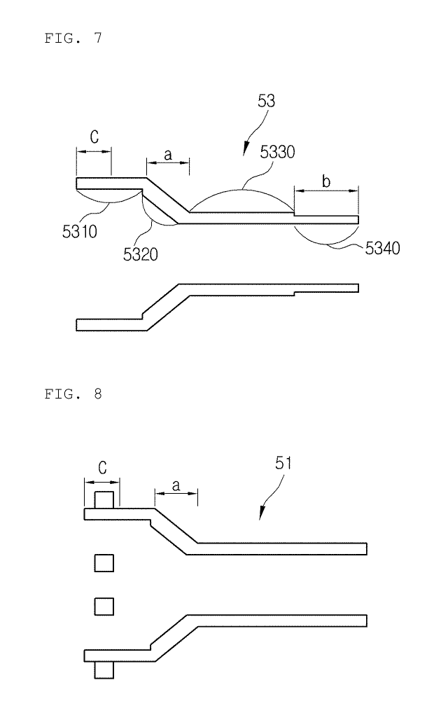

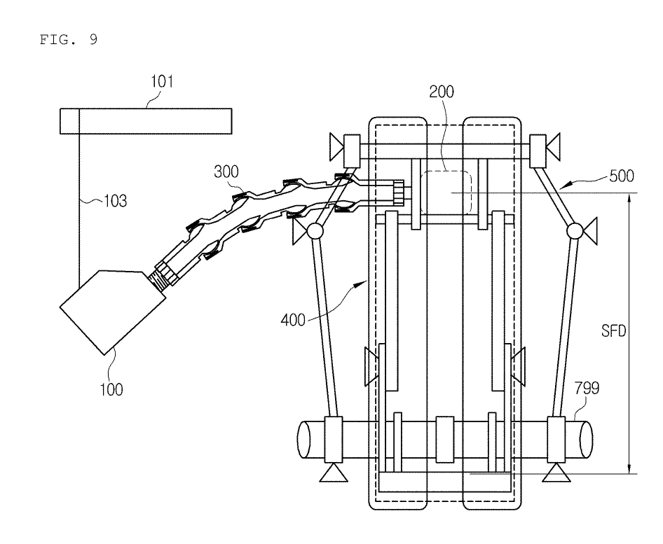

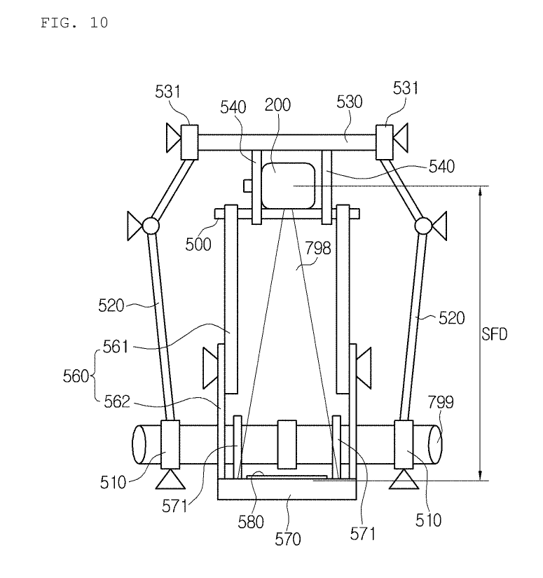

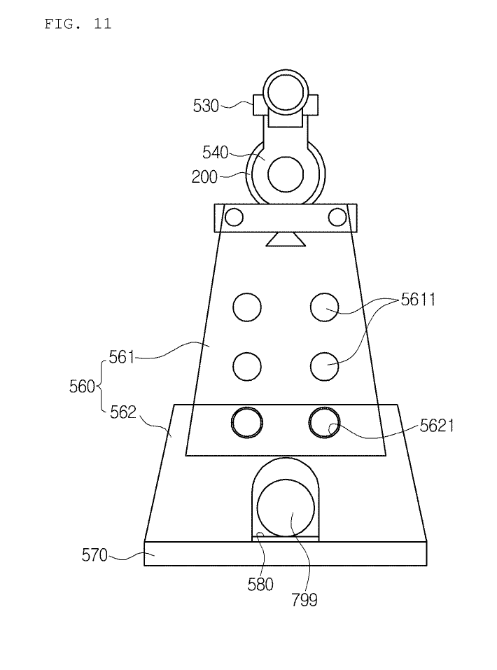

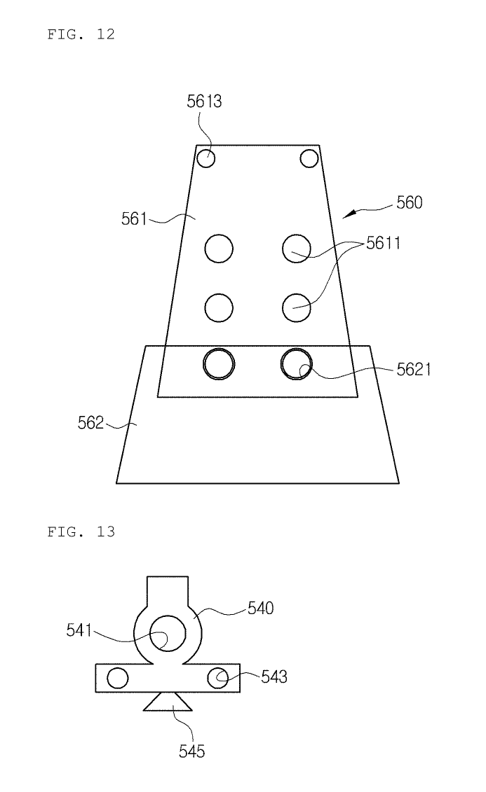

FIG. 2 is a front view of a radiation shielding tube according to a first preferred embodiment of the present invention, FIGS. 3 and 4 are plan views of the radiation shielding tube according to the preferred embodiment of the present invention, FIG. 5 is a sectional view of the radiation shielding tube according to the preferred embodiment of the present invention, FIG. 6 is a sectional view showing a second shielding joint of the radiation shielding tube according to the preferred embodiment of the present invention, FIG. 7 is a sectional view showing a third shielding joint of the radiation shielding tube according to the preferred embodiment of the present invention, and FIG. 8 is a sectional view showing a first shielding joint of the radiation shielding tube according to the preferred embodiment of the present invention.

Referring to FIGS. 2 to 8, the radiation shielding tube according to the first preferred embodiment of the present invention includes a guide tube 20 which connects a radiation source container 10 and a collimator 20 with each other. The guide tube 50 is in an articular form to be bendable.

The guide tube 50 connects the radiation source container 10 and the collimator 20 with each other so as to serve as a passage in which a radiation source 40 moves, and can shield radiation generated during movement of a radiation source or RT work.

The guide tube 50 is made of tungsten or the like which is excellent in radiation shielding performance. In this instance, the guide tube 50 is made of tungsten with purity of more than 99%, or tungsten-alloy with purity of more than 96% in consideration of field applicability and durability.

That is, if the guide tube is made of materials with relatively low density, such as silicon or iron, it has good flexibility but is deteriorated in radiation shielding performance. The radiation shielding tube according to the preferred embodiment of the present invention enhances radiation shielding performance because the guide tube is made of tungsten or the like, which is relative high in density. If the guide tube is made of tungsten or the like, which is relative high in density, it is relatively deteriorated in flexibility. So, in order to solve the problem, the guide tube is made in an articular form to be bendable so that the guide tube can move according to various installation positions of the collimator.

The guide tube 50 has joints, which are overlapped and connected with one another. That is, the guide tube 50 includes: a first shielding joint 51 connected to the collimator 20; a second shielding joint 52 connected to the radiation source container 10; and one or more third shielding joints 53 connecting the first shielding joint 51 and the second shielding joint 52 with each other. In this embodiment, there are four third shielding joints, but the number of the third shielding joints can be increased or decreased properly. The first shielding joint 51 includes a connector 5110 for connecting with the collimator 20, and the second shielding joint 52 has a connector 5210 for connecting with the radiation source container 10.

In other words, the guide tube 50 has unit joint tubes in pieces, which are partially overlapped with one another to be connected with one another in an articular form, so that the guide tube 50 can move according to an installation position of the collimator 20.

As shown in FIGS. 2 and 3, if the radiation source container 10 and the collimator 20 are connected with each other in a straight line, the guide tube 50 is also in a straight line, such that workers are less vulnerable to radiation because the radiation source exposed to the back of the collimator 20 through the guide tube faces the radiation source container 10.

In the majority of cases, as shown in FIG. 4, the radiation source container 10 and the collimator 20 are connected with each other in a nonlinear form, and in this instance, the guide tube 50 is bent into a curved form, so radiation exposed to the back of the collimator 20 through the guide tube directly influences on the workers during RT work and it may cause a great danger of bombing. However, the radiation shielding tube according to the preferred embodiment of the present invention can constantly shield radiation even in a bent state as shown in FIG. 4. The unexplained reference numeral 30 designates a pipe.

The radiation shielding tube according to the preferred embodiment of the present invention secures flexibility because the guide tube is bendable according to various installation positions of the collimator. In other words, the guide tube can simultaneously secure radiation shielding performance and flexibility as being made of tungsten with relatively high density and having unit tubes configured in the articular form to be bendable. Additionally, such a shielding effect of the guide tube is maximized through a connection structure between the unit tubes and its detailed shape which will be described later.

The guide tube 50 is configured such that inner diameters of the joints have uniform thickness at all parts. Therefore, the guide tube can keep uniform shielding performance at any part.

The guide tube 50 is configured to have a diameter (inner diameter) of one end larger than that of the other end so that the unit joints are connected with one another to be movable. The thickness of the guide tube may be controlled according to required shielding performance.

The unit joints are configured such that one end of one unit joint is inserted into one end of another unit joint to be overlapped with each other and the two unit joints are connected with each other via a connection pin 54 to be rotatable on the connection pin 54.

Each of the unit joints of the guide tube 50 includes: an overlap zone c which is formed at one end portion such that an end portion of a neighboring unit joint is inserted into the end portion of the former unit joint to be overlapped; a driving part margin zone a extending from the overlap zone c to secure an available space when the unit joints rotate mutually; and an overlap margin zone b formed at the other end portion to be inserted into the overlap zone c of another neighboring unit joint.

The overlap zone c is a section ranging from one end portion of the unit joint to a place where the overlap margin zone b of the neighboring unit joint is inserted. Therefore, a pair of the unit joints which are connected with each other are overlapped with each other as long as the overlap zone c. The driving part margin zone a is a space where the unit joints connected with each other can move. The overlap margin zone b is a section ranging from the other end portion of the unit joint to a place where the unit joint is inserted into the overlap zone c of the neighboring unit joint.

The overlap margin zone b is inserted and connected into the overlap zone c of the neighboring unit joint to be overlapped. A space is formed in a radial direction between the overlap zone c and the overlap margin zone b. In this instance, the thicknesses of the overlap zone c and the overlap margin zone b are smaller than or equal to the thickness of the driving part margin zone a. As an example, the basic thickness of each unit joint is 7 t. That is, the driving part margin zone a is 7 t in thickness, and the overlap zone c and the overlap margin zone b are 5 t in thickness.

The overlap zone c and the overlap margin zone b are sections that are overlapped with each other, so the actual thickness of the two zones is 10 t. However, because shielding performance is reduced by a space formed between the overlap zone c and the overlap margin zone b, the overlap section of the overlap zone and the overlap margin zone actually has shielding performance similar to tungsten with thickness of about 7 t. Finally, the guide tube shows shielding performance as much as the basic thickness of about 7 t in all sections and provides uniform shielding performance.

Each of the unit joints of the guide tube includes: a first tube part 5310, which is formed at an end portion and has a uniform inner diameter such that an end portion of a neighboring unit joint is inserted into the first tube part to be overlapped; a second tube part 5320, which has an inner circumferential surface inclined so that the inner diameter gets gradually smaller inside the first tube part 5310; a third tube part 5330, which has a uniform inner diameter extending from the second tube part 5320; and a fourth tube part 5340, which has a uniform inner diameter extending from the third tube part 5330 and is inserted into the first tube part 5310 of a neighboring unit joint to be overlapped.

The second tube part 5320 has a predetermined inclined structure inside an inner passage of the guide tube, so that the guide tube can shield radiation through the structure of the joint tube and make intensity of radiation gradually weaker in the bent state of the guide tube as shown in FIG. 4. Due to the different inner diameters of the first tube part 5310 and the third tube part 5330 and the inclined structure of the second tube part 5320 between the first tube part 5310 and the third tube part 5330, the guide tube can be bent smoothly at each joint portion, and cover radiation exposed to the back of the collimator 20 at the overlap part so as to attenuate radiation exposed to the air.

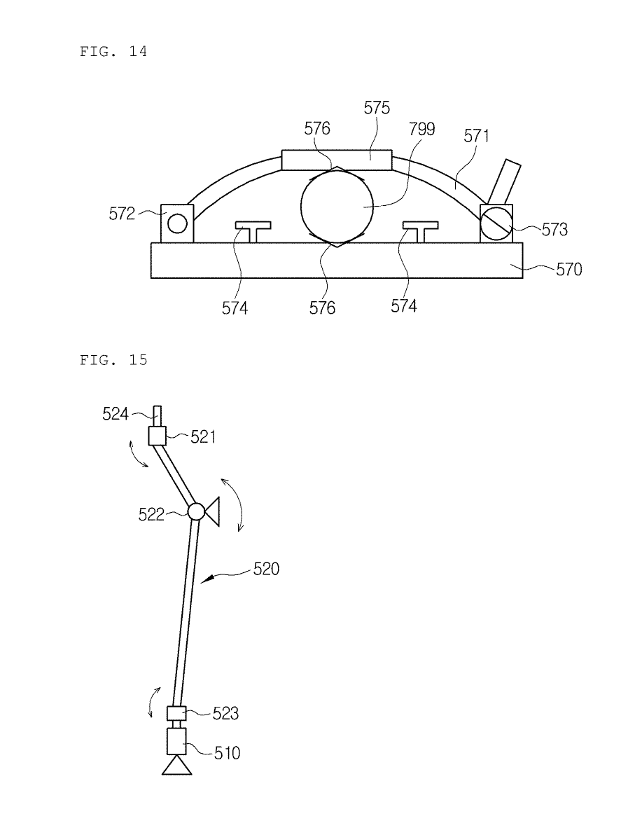

FIG. 9 is a front view of a shielding device of a pipe according to a second preferred embodiment of the present invention.

In FIG. 9, the right-and-left direction is a longitudinal direction, and the up-and-down direction is an irradiation direction of radiation.

As shown in FIG. 9, the shielding device of the pipe includes a radiation source 100, a collimator 200, a guide tube 300, a radiation shield 400, and a jig part 500.

The radiation source 100 is formed as a radiation source container and can be connected to a supporting means 101 through a wire 103. The collimator 200 is fixed to a collimator holder 540 of the jig part 500 which will be described later, and investigates radiation toward a welding inspection part of a pipe 799. The guide tube 300 connects the radiation source 100 with the collimator 200. The structure of the guide tube 300 will be described later in detail.

The radiation shield 400 may be formed in a flexible pad type. The radiation shield 400 is configured to surround at least a part of the collimator 200 or at least a part of the space between the collimator 200 and the pipe 799 to shield radiation investigated from the collimator 200. The radiation shield 400 includes a plurality of lead beads arranged therein, and is an outer cover for covering the lead beads. The radiation shield 400 will be described later in detail.

The jig part 500 fixes the collimator 200 and supports the radiation shield 400. The jig part 500 can control a distance between the collimator 200 and the pipe 799.

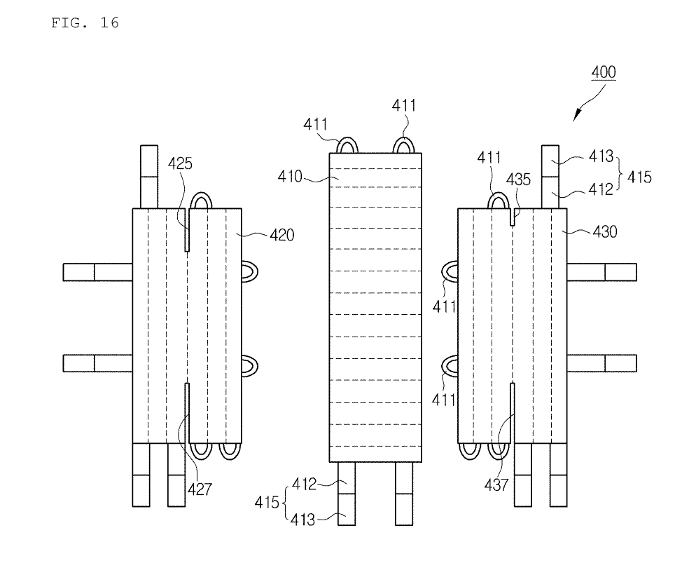

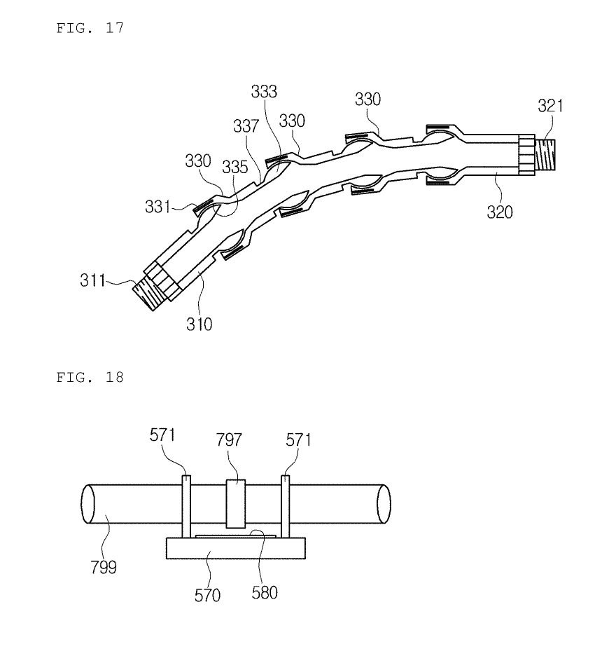

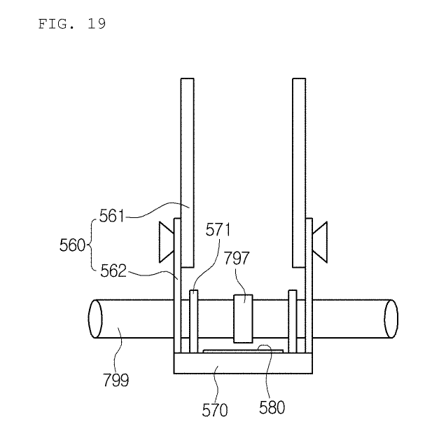

FIG. 10 is a front view showing a jig part of the shielding device of the pipe according to the second preferred embodiment of the present invention, FIG. 11 is a side view showing the jig part of the shielding device of the pipe according to the second preferred embodiment of the present invention, and FIG. 12 is a side view showing an auxiliary shield supporter of the shielding device of the pipe according to the second preferred embodiment of the present invention.

Referring to FIGS. 10 to 12, the jig part 500 includes a supporter part, articulated arms 520, and a shielding block 570.

The supporter part is connected to the pipe 799, supports the radiation shield 400, and fixes the collimator 200. The supporter part includes auxiliary shield supporters 560, a side shield supporter 550, a collimator holder 540, and a central shield supporter 530.

The auxiliary shield supporters 560 are combined to the shielding block 570, and are formed at both sides of a pipe welding part 797. The auxiliary shield supporters 560 have a plate form with a predetermined thickness in a longitudinal direction of the pipe, and extend toward the collimator 200 from the shielding block 570.

The auxiliary shield supporters 560 are a first auxiliary supporter 562 and a second auxiliary supporter 561.

The first auxiliary supporter 562 has a lower end portion combined to the shielding block 570 and an upper end portion extending toward the collimator 200. The first auxiliary supporter 562 has first assembly holes 5621.

The second auxiliary supporter 561 is to combine the side shield supporter 550 which will be described later, and extends toward the collimator 200 from the first auxiliary supporter 562. The second auxiliary supporter 561 is similar in shape to the first auxiliary supporter 562, and is connected to be slidable in a vertical direction, namely, in an irradiation direction of radiation, relative to the first auxiliary supporter 562. The second auxiliary supporter 561 has a plurality of second assembly holes 5611 formed at the corresponding position of the first assembly holes 5621 in a sliding direction.

Bolts pass through the first assembly holes 5621 and the second assembly holes 5611 and are fit to the assembly holes. The SFD may be controlled by fixing the bolts while sliding the second auxiliary supporter 561 relative to the first auxiliary supporter 562 according to the diameter of the pipe.

The side shield supporter 550 connects the auxiliary shield supporters 560 which are spaced apart from each other in the longitudinal direction of the pipe, and is formed side by side with the pipe 799. The side shield supporter 550 is combined to the second auxiliary supporter 561 of the auxiliary shield supporter 560, and the second auxiliary supporter 561 has a side shield supporter hole 5613 to which the side shield supporter 550 is inserted.

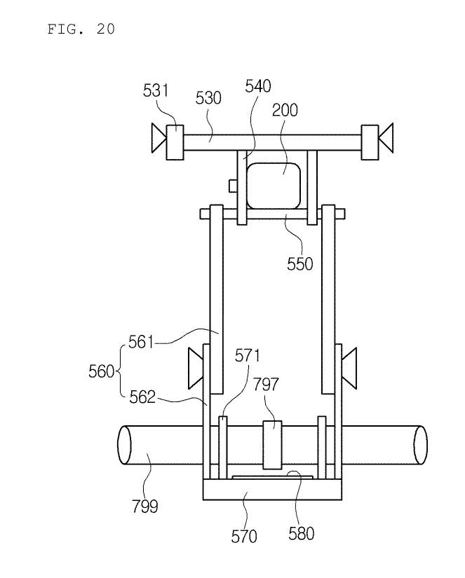

The collimator holder 540 is combined to the side shield supporter 550 and fixes the collimator 200. FIG. 13 is a side view showing a collimator holder of the shielding device of the pipe according to the second preferred embodiment of the present invention. Referring to FIG. 13, the collimator holder 540 has a collimator hole 541 which is formed to penetrate the pipe in the longitudinal direction, and the collimator 200 is inserted into the collimator hole 541. A collimator fixing bolt 545 for fixing the collimator 200 inserted into the collimator hole 541 is disposed below the collimator hole 541. Moreover, the collimator holder 540 further includes a side shield hole 543 for fixing the side shield supporter 550 which is inserted into the side shield hole 543.

The central shield supporter 530 is to combine articulated arms 520 which will be described later, and is combined to the collimator holder 540. The central shield supporter 530 is fixed at the top of the collimator holder 540, and extends side by side with the side shield supporter 550. The central shield supporter 530 has connection members 531 disposed at both sides in the longitudinal direction to be combined to the articulated arms 520.

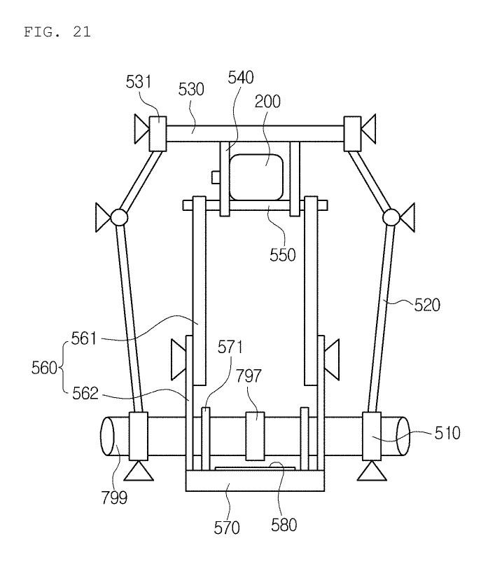

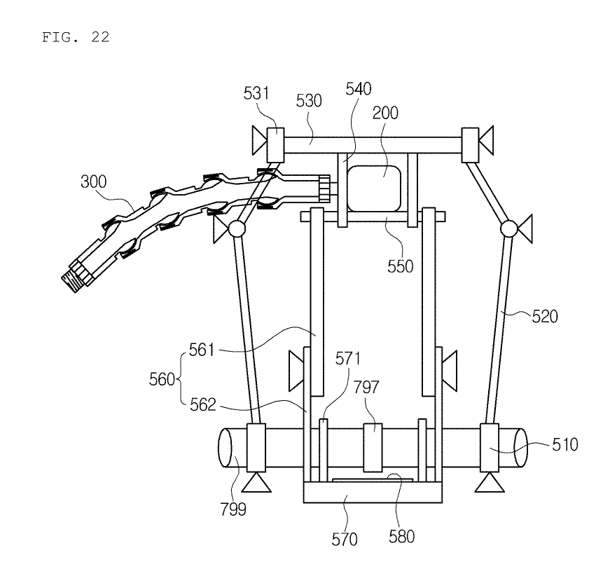

FIG. 14 is a side view showing a shielding block of the shielding device of the pipe according to the second preferred embodiment of the present invention, and FIG. 15 is a front view showing articulated arms of the shielding device of the pipe according to the second preferred embodiment of the present invention. Referring to FIGS. 14 ad 15, the articulated arms 520 are disposed at both sides of the pipe in the longitudinal direction one by one. One of the articulated arms is combined to the pipe 799 and the other is combined to the supporter part.

The articulated arm 520 has one or more joints 521, 522 and 523. In this embodiment, there are three joints, but the number of the joints may be adjusted properly.

The articulated arm 520 has a pipe clamp 510 disposed at one side to be combined while surrounding the outer circumferential surface of the pipe 799, and the pipe 799 is formed to be rotatable at 360 degrees on a shaft center relative to the pipe clamp 510. At the time of radiography at different positions relative to the same pipe welding part, namely, at different angles, for instance, 180 degrees or 360 degrees, on the shaft center, RT work can be easily performed at various angles by freely rotating the pipe 799 from the clamp 510. A connection pin 524 which is inserted and fixed into the connection member 531 of the central shield supporter 530 is disposed at an end portion of one side of the articulated arm 520.

The shielding block 570 is made of lead, tungsten or the like, is arranged at the rear end of the pipe 799 in the irradiation direction, and a film 580 is arranged on a face opposed to the pipe 799. The shielding block 570 includes: a pipe fixing rope 571 for fixing the shielding block 570 to the pipe 799 by surrounding the outer circumferential surface of the pipe 799; and an auxiliary shield supporter holder socket 574 for combining the supporter part.

Furthermore, the shielding block 570 includes: a rope fixing base 572 for fixing one side of the pipe fixing rope 571; a rope holder 573 for fixing the other side of the pipe fixing rope 571 so that the pipe 799 is bound between the pipe fixing rope 571 and the shielding block 570; a pipe fixing holder 575 formed at the central portion of the pipe fixing rope 571 to tightly bind the pipe 799; and pipe protective pads 576 interposed between the shielding block 570 and the pipe 799 and between the pipe fixing holder 575 and the pipe 799.

The rope holder 573 is configured to be able to fix and release the pipe fixing rope 571, so that the pipe 799 is rotatable at 360 degrees on the shaft center when the rope holder 573 releases the pipe fixing rope 571. Preferably, the rope holder 573 is configured to easily fasten or release the rope 571, like an automatic bar or an automatic buckle. The pipe 799 is located between a pair of the pipe protective pads 576 to surround the rope 571, and when the rope 571 is tightened in the rope holder 573, the pipe fixing holder 575 moves in the direction that the pipe fixing holder gets closer to the pipe 799 so that the rope 571 is tightened.

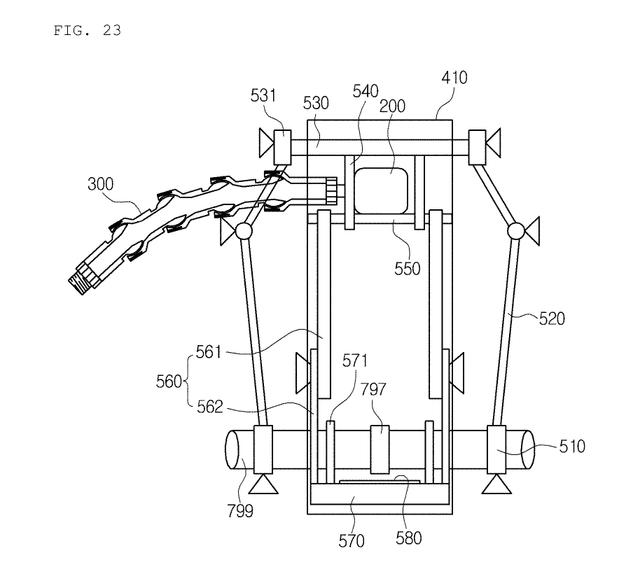

FIG. 16 is a view showing a radiation shield of the shielding device of the pipe according to the second preferred embodiment of the present invention. Referring to FIG. 16, the radiation shield 400 includes a central shield 410 and side shields 420 and 430.

The central shield 410 is mounted to hang on the central shield supporter 530 and vertically extends to the shielding block 570. The central shield supporter 530 has a plurality of space parts partitioned vertically, which is filled with a plurality of lead beads in a horizontal direction. The central shield 410 has steel rings 411, and male and female Velcro types 412 and 413 are pulled and fixed after passing through the steel rings 411 at their mounted positions.

The side shields 420 and 430 are respectively mounted to surround the side shield supporter 550 and the auxiliary shield supporter 560, and have a plurality of space parts which are filled with a plurality of lead beads in a vertical direction. The side shields 420 and 430 have steel rings 411, and male and female Velcro types 412 and 413 are pulled and fixed after passing through the steel rings 411 of the side shields 420 and 430 at their mounted positions.

Furthermore, the side shields 420 and 430 have cut portions 425, 427, 435 and 437 formed in the vertical direction. That is, the side shield 420 of the left side facing with the guide tube 300 includes a first cut portion 425 formed inwardly from the upper end surface so that the guide tube 300 is mounted at the upper side; and a second cut portion 427 formed inwardly from the lower end surface so that the pipe 799 is mounted at the lower side. The side shield 430 of the right side includes a third cut portion formed inwardly from the upper end surface so as to secure a space for avoiding interference with the jig part 500 at the upper side; and a fourth cut portion 437 formed inwardly from the lower end surface so that the pipe 799 is mounted on the lower side.

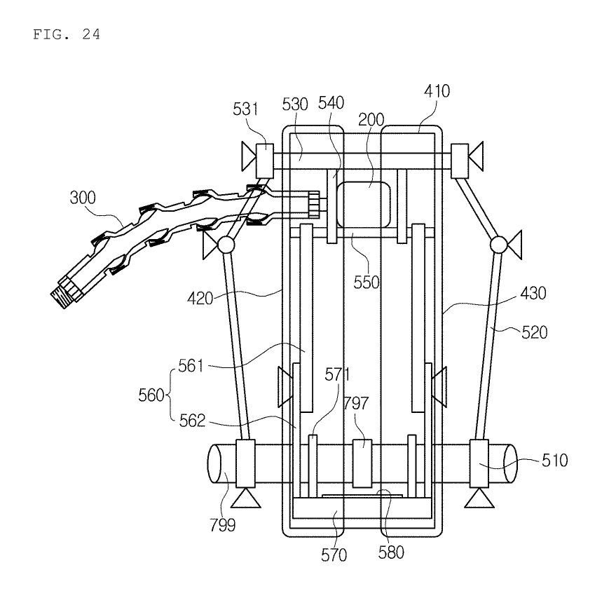

FIG. 17 is a sectional view showing a guide tube of the shielding device of the pipe according to the second preferred embodiment of the present invention. Referring to FIG. 17, the guide tube 300 is made of tungsten, and a plurality of joints are connected with one another to be bendable. The guide tube 300 includes: a first joint 310 connected to the radiation source 100; a second joint 320 connected to the collimator 200; and one or more third joints 330 which connect the first joint 310 and the second joint 320 with each other and is configured to properly increase or decrease the number of joints. The first joint 310 has a connection part 311 to be connected to the radiation source 100, and the second joint 320 has a connection part 321 to be connected to the collimator 200.

Each of the joints of the guide tube 300 includes a spherical ball 333 formed at an end portion, a ball recess 335 formed at the other end portion to rotatably receive the ball 333 of a neighboring joint, a bolt 331 disposed to restrict the ball 333 of the neighboring joint, and a driving groove 337 formed on the outer circumferential surface of the joint to be dented inwardly in a stepwise form so as to prevent interference when the joints are rotated.

The ball-type tungsten guide tube is to connect the radiation source 100 with the collimator 200, and serves to shield radiation leaking during movement of the radiation source 100 or radiography of the radiation source. Through the structure, the guide tube is flexible according to various working conditions and increase flexibility when being bents through the driving groove 337.

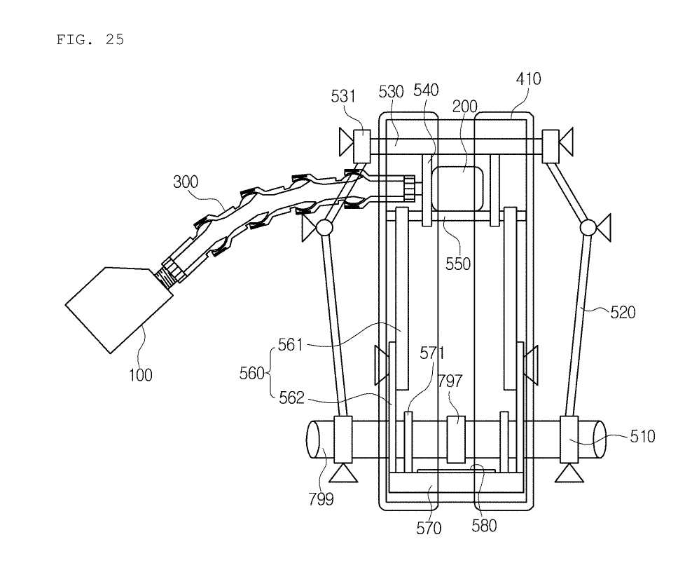

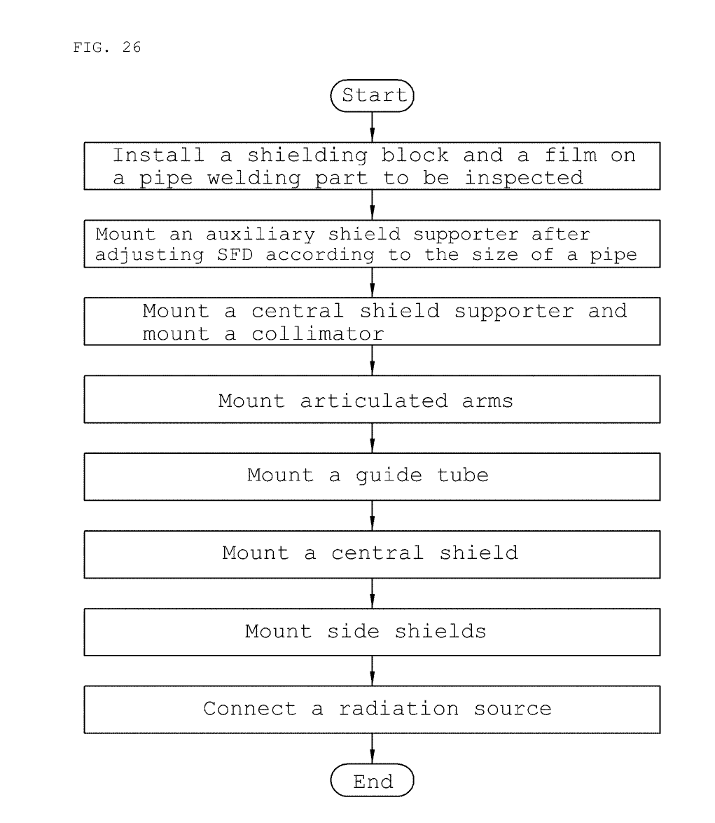

In the meantime, FIGS. 18 to 25 are views showing a shielding method of a pipe in order according to a third preferred embodiment of the present invention, and FIG. 26 is a flow chart showing the shielding method of the pipe according to the third preferred embodiment of the present invention.

Referring to FIGS. 18 to 26, the shielding method of the pipe according to the third preferred embodiment of the present invention includes the steps of: mounting the shielding block 570 and the film 580 on the welding part 797 of the pipe 799 to be inspected; mounting the auxiliary shield supporter 560 on the shielding block 570 after adjusting the SFD according to the size of the pipe; mounting the central shield supporter 530 and the collimator 200; mounting the articulated arms 520 between the pipe 799 and the central shield supporter 530; mounting the guide tube 300 on the collimator 200; hanging the central shield 410 on the central shield supporter 530; mounting side shields 420 and 430 to surround the auxiliary shield supporter 560; and connecting the radiation source 100 to the guide tube 300.

Referring to FIG. 18, first, the shielding block 570 and the film 580 are mounted on the welding part 797 of the pipe 799. The film 580 is fixed on the upper surface of the shielding block 570, and binds the rope 571 to fix the shielding block 570 to the pipe 799. Referring to FIG. 19, the auxiliary shield supporter 560 is mounted on the shielding block 570 after the SFD is adjusted according to the size of the pipe 799 to be inspected.

Referring to FIG. 20, the side shield supporter 550 is bound on the auxiliary shield supporter 560, so that the central shield supporter 530 is mounted. The central shield supporter 530 may be combined integrally with the side shield supporter 550 by the medium of the collimator holder 540 or may be assembled to the side shield supporter 550 through a combining process. The collimator 200 is mounted on the collimator holder 540.

Referring to FIG. 21, the articulated arms 520 are mounted. The pipe clamp 510 is connected to the pipe 799 and the connection pin 524 formed at the opposite side is connected to the connection member 531 of the central shield supporter 530, such that the articulated arms 520 are mounted. Referring to FIG. 22, the guide tube 300 is connected to the collimator 200. After that, as shown in FIG. 23, the central shield 410 is mounted, and then, the side shields 420 and 430 are mounted as shown in FIG. 24. Finally, as shown in FIG. 25, the radiation source 100 is connected to the guide tube 300.

As described above, while the radiation shielding tube, and the shielding device and method according to preferred embodiments of the present invention have been particularly shown and described with reference to the example embodiments thereof, it will be understood by those of ordinary skill in the art that the above embodiments of the present invention are all exemplified and various changes, modifications and equivalents may be made therein without changing the characteristics and scope of the present invention. Therefore, it would be understood that the protective scope of the present invention shall be defined by the technical ideas of the following claims.

1. A radiation shielding, tube comprising a guide tube connecting a radiation source container and a collimator with each other, wherein the guide tube is formed in an articular form to be bendable.

2. The radiation shielding tube according to claim 1, wherein the guide tube has joints which are connected with one another to be overlapped with one another.

3. The radiation shielding tube according to claim 2, wherein the guide tube comprises:
a first shielding joint connected to the collimator;
a second shielding joint connected to the radiation source container; and
one or more third shielding joints connecting the first shielding joint and the second shielding joint with each other.

4. The radiation shielding tube according to claim 1, wherein the guide tube is configured such that inner diameters of the joints have uniform thickness at all parts.

5. The radiation shielding tube according to claim 1, wherein the unit joint of the guide tube comprises: an overlap zone which is formed at one end portion such that an end portion of a neighboring unit joint is inserted into the end portion of the former unit joint to be overlapped; a driving part margin zone extending from the overlap zone to secure an available space when the unit joints rotate mutually; and an overlap margin zone formed at the other end portion to be inserted into the overlap zone of another neighboring unit joint.

6. The radiation shielding tube according to claim 5, wherein the overlap margin zone is Inserted and connected into the overlap zone of the neighboring unit joint To be overlapped, and a space is formed in a radial direction between the overlap zone and the overlap margin zone, and
wherein the thicknesses of the overlap zone and the overlap margin zone are smaller than or equal to the thickness of the driving part margin zone.

7. The radiation shielding tube according to claim 1, wherein the unit joint of the guide tube comprises: a first tube part, which is formed at an end portion and has a it iform inner diameter such that an end portion of a neighboring unit joint is inserted into the first tube part to be overlapped; a second tube part, which has an inner circumferential surface inclined so that the inner diameter gets gradually smaller inside the first tube part; a third tube part, which has a uniform inner diameter extending from the second tube part; and a fourth tube part, which has a uniform inner diameter extending from the third tube part and is inserted into the first tube part of a neighboring unit joint to be overlapped.

8. A shielding device of a pipe comprising:
a radiation shield configured to surround at least a part of the collimator or at least a part of the space between the collimator and the pipe to shield radiation investigated from the collimator; and
a jig part which fixes the collimator and supports the radiation shield,
wherein the jig part controls a distance between the collimator and the pipe.

9. The shielding device according to claim 8, wherein the jig part comprises:
a supporter part which is connected to the pipe, supports the radiation shield, and fixes the collimator; and
articulated arms having one side combined to the pipe and the other side combined to the supporter part, and at least one joints.

10. The shielding device according to claim 9, wherein the jig part comprise:
a shielding block which is arranged at the rear end of the pipe in an irradiation direction of radiation, and a film is arranged on a face opposed to the pipe.

11. The shielding device according to claim 10. wherein the supporter part comprises:
auxiliary shield supporters which are combined to the shielding block, are formed at both sides of a pipe welding part, and extend toward the collimator;
a side shield supporter which connects a pair of the auxiliary shield supporters with each other and are formed side by side with the pipe;
a collimator holder which is combined to the sirae shield supporter and fixes the collimator; and
a central shield supporter which combines the articulated arms, is combined to the collimator holder, and is formed side by side with the side shield supporter.

12. The shielding device according to claim 11, wherein the auxiliary shield supporter comprises:
a first auxiliary supporter which is combined to the shielding block and has first assembly holes; and
a second auxiliary supporter for combining the side shield supporter, the second auxiliary supporter which extends from the first auxiliary supporter toward the collintator, is connected to be slidable relative to the first auxiliary supporter, and has a plurality of second assembly holes formed at the correspondin.g position of the first assembly holes in a sliding direction.

13. The shielding device according to claim 9, wherein the articulated arm has a pipe clamp disposed at one side to be combined while surrounding the outer circumferential surface of the pipe, and the pipe is formed to be rotatable at 360 degrees on a shaft cemer relative to the pipe clamp.

14. The shielding device according to claim 10, wherein the shielding block coinpriscs: a pipe fixing rope for fixing the shielding block to the pipe by surrounding the outer circumferential surface of the pipe; and an auxiliary shield supporter holder socket for combining the supporter part.

15. The shielding device according to claim 14, wherein the shielding block comprises: a rope fixing base for fixing one side of the pipe fixing rope; a rope holder for fixing the other side of the pipe fixing rope so that the pipe is bound between the pipe fixing rope and the shielding block; a pipe fixing holder formed at the central portion of the pipe fixing rope to tightly bind the pipe; and pipe protective pads interposed between the shielding block and the pipe and between the pipe fixing holder and the pipe.

16. The shielding device according to claim 15, wherein the rope holder is configured to be able to fix and release the pipe fixing rope so that the pipe is rotatable at 360 degrees on the shaft center when the rope holder releases the pipe fixing, rope.

17. The shielding device according to claim 8, further comprising:
a guide tube which connects the radiation source and the collimator with each other.

18. The shielding device according to claim 17, wherein each of the joints of the guide tube comprises a spherical ball formed at an end portion, a ball recess formed at the other end portion to rotatably receive the ball of a neighboring joint, a bolt disposed to restrict the ball of the neighboring joint, and a driving groove formed on the outer circumferential surface of the joint to be dented inwardly in a stepwise form so as to prevent interference when the joints are rotated.

19. The shielding device according to claim 11, wherein the radiation shield comprises:
a central shield which is mounted to hang on the central shield supporter and vertically extends to the shielding block and has a plurality of space parts partitioned vertically, which is filled with a plurality of lead heads in a horizontal direction; and
side shields which are respectively mounted to surround the side shield supporter and the auxiliary shield supporter, and have a plurality of space parts which are filled with a plurality of lead beads in a vertical direction.
